(19) United States
(12) Patent Application Publication
(10) Pub. No.: US 2022/0103496 A1
(43) Pub. Date: Mar. 31, 2022

(54) DIGITAL NOTIFICATION ENHANCEMENT SYSTEM

(71) Applicant: Jeffrey Charles Calhoun, Lake Isabella, MI (US)

(72) Inventor: Jeffrey Charles Calhoun, Lake Isabella, MI (US)

(21) Appl. No.: 17/035,044

(22) Filed: Sep. 28, 2020

(51) Int. Cl. H04L 12/58; H04L 29/06; G06Q 10/10

(52) U.S. Cl. CPC H04L 51/12; H04L 51/38; G06Q 10/107; H04L 63/126; H04L 51/24

(57) ABSTRACT

An electronic message verification system to be used in conjunction with pre-existing messaging platforms as an add-in feature for security, peace of mind and protection against malicious online attacks. Providing its users with a customizable visual notification, a vetted message received is in fact from its intended verified sender and not from a fraudulent sender. That visual notification can be personalized by modifying the text of the notification, the font family, font size and font color as well as the size and color of the banner in which the personalized notification appears. The invention uses cloud-based data warehouses, data logs and a series of hashes attached to the body of messages to confirm the authenticity of the sender if the sender too has the invention installed.

### RELATED APPLICATIONS

The present application claims priority to and incorporates by reference thereto, U.S. Provisional Patent Application No. 62/907,570 filed on Sep. 28, 2019.

### BACKGROUND

### Field of the Invention

This invention relates to an apparatus and method for a digital notification enhancement & verification system.

### Background of the Invention

Emails and other notices are now ubiquitous. It is not uncommon for people, especially in the business context, to receive hundreds of emails a day that have varying degrees of importance. Phishing and other forms of electronic attacks have become commonplace. Users have a difficult time understanding which emails are safe to respond to. There are many security applications that are utilized by businesses and individuals that attempt to keep out spoofed emails and other attacks. Our product has been designed to provide personalized and intuitive visual verification of emails that are safe to click on and respond to.

There are several ways to combat phishing. The two most popular are blocking malicious emails at the server and user education. They are used in conjunction in most organizations. Currently, there are a number of products that can block phishing emails through an email gateway or at post-delivery at the email server itself. They can block emails that look forged, are copies of emails that the system already knows are phishing emails, by heuristics (system looks at many phishing emails and can guess if the email is a phishing scam or not) or anomalistic (looking for anomalies in network behavior). However, these systems are not one hundred percent accurate and are almost completely ineffective against spear phishing. User education is the second way to combat phishing. The end users are trained to look for clues to tip them off to phishing emails and don't click on anything that might be suspicious. User education, like the blocking emails at the server, is not one hundred percent effective and it is expensive on many fronts. Each employee must be trained to be an expert in detecting phishing along with their other job duties. The training is expensive in its initial cost, the cost of the time that each employee spends in training and away from their duties, and the cost of the time spent for each employee trying to figure out whether an email is a phishing email or a legitimate one. Lastly, it is extremely costly when one or both of these methods fail as they are completely ineffective against spear phishing.

There is another way that organizations combat phishing in extreme cases and that is whitelisting. Whitelisting is the practice of only allowing emails from an approved list of email addresses. This adds a layer of bureaucracy to an end user's normal workflow. They must have each email address pre-approved before they can send or receive an email from the approved address. This may block many legitimate emails that have not been white listed. Whitelisting has its weakness; an email address can still be spoofed, and phishing attacks can get by the system if this happens.¹ ¹ “Phishing Attacks by the Numbers.” Digital Information World, 6 Mar. 2019, www.digitalinformationworld.com/2019/03/phishing-attacks-by-numbers.html.

There are other attacks besides phishing that hackers can take advantage of. A Man-in-the-middle attack consists of a hacker inserting themselves between the sender and receiver of an email and alters the email in route to the receiver for malicious intent. These are difficult to detect and combat. The last major attack vector is for a hacker to take over a legitimate account. These are extremely difficult to discover.

### SUMMARY OF THE INVENTION

The present invention comprises a digital notification verification system. The invention translates the code/language and/or rules used to define and/or create specific action, format, and/or color across mediums in order display the information in a new and innovative way. The personalized notification appears as a banner in the message screen. The personalized verification display options include company logo, your choice of text input, font family, size of font, color of font as well as the color and size of banner in which the custom text is within.

Notifications include but are not limited to emails, texts, and tweets. Notifications can occur on, across and/or between any digital communication devices. Devices include computers, tablets, mobile phones and other smart devices. The invention allows the user to have clear and simple verification to easily recognize and identify electronic communications as verified and safe.

### BRIEF DESCRIPTION OF THE DRAWINGS

FIG. 1 shows an implementation of the present invention.

FIG. 2 shows a flow diagram of the server/client program environment.

FIG. 3 shows terminology supporting FIG. 2

FIG. 4 is a block diagram showing the present invention in the context of several different OSs.

FIG. 5 is a block diagram of the invention running as a web-based server application

FIG. 6 is a block diagram of the architecture of firewall protection.

### DETAILED DESCRIPTION OF THE DRAWINGS

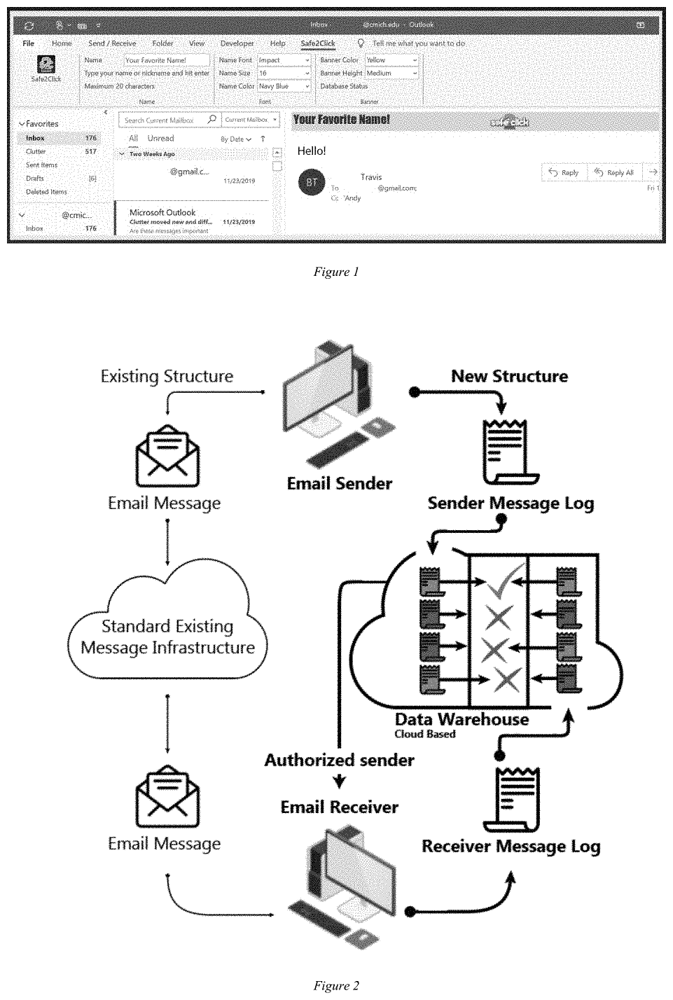

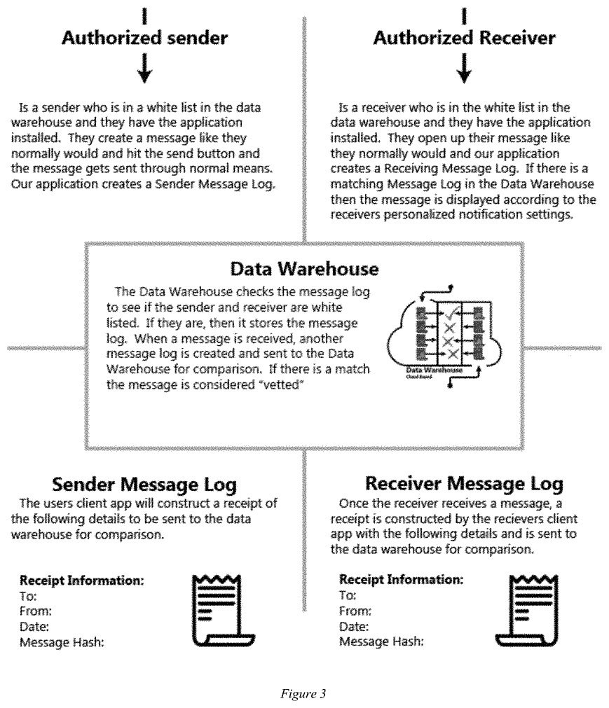

Safe2Click message verification system can work on any messaging platform. All examples and diagrams will use email as the messaging platform. FIG. 1 is an example of using the Safe2Click add-in within an Outlook email application. The yellow bar at the top of the email body is fully customizable using the Safe2Click tab on the Outlook toolbar ribbon. The user has the option to configure and personalize the look of the notification banner. The personalization choices are the choice of text to be displayed in the banner, the font family in which the text is displayed, color of font, size of the font, background color of the banner and size of the banner. The banner will only appear when a message has been verified. FIG. 2 shows the process of a message delivery in both the conventional way on the left path and the inventions verification procedure on the right path. FIG. 3 goes into more detail and defines the terminology of the invention. The following is a step by step guide to how this happens. First, the term vetted is explained.

“Vetted” means the following things:
1) The message was sent from a computer with our application installed, used by an authorized email address.
   a) This is checked by the data warehouse.
2) The message was not tampered with in route.
   a) This accomplished by hashing the message at both the sending end and the receiving end and comparing the hashes. If they are equal, then the message has not tampered with.
3) The message was received from a computer with our application installed, used by an authorized email address.

The email messaging system as an example by a small fictitious company “CMH Inc.” CMH has 15 employees, including the CEO. CMH also does business with 3 trusted local vendors outside of the CMH Company.
1) Safe2Click uses a client/server architecture. The application is installed on the client machines and the server is stored in the cloud.
   a) The client application is installed on all 15 employees' computers with the help of CMH's IT administrator.
   b) The application is also installed on 3 trusted local vendors' computers with the help of vendors' IT staff.
   c) The IT administrator uploads CMH' s vetted user list to the server that includes all the employees and the trusted vendors.
2) Personalization
   a) Each of the employees and trusted vendors get to personalize how the vetted message notification will look.
      i) They get to personalize the message. They can choose a nick name, favorite sports team, “safe message”, “you can click on this”, etc. In this instance we will choose “Your Favorite Name” as our personalized message.
   b) They get to choose the font
   c) Font color
   d) Font Size
   e) Notification color
   f) Notification Size
3) The CEO wants to send out an email to all the employees, trusted vendors, and a few local politicians, to invite them to CMH's annual picnic and fund raiser.
   a) The CEO crafts the email exactly like he normally would on his work computer.
      i) The email contains a link to donate money to the local Big Brothers Big Sisters of America organization.
      ii) He adds the addresses of employees, trusted vendors and politicians to the email and sends the email message.
   b) The message gets sent via normal email to all CMH's employees, trusted vendors, and the local politicians.
      i) At the time the message is sent, our application creates a message log of the email being sent for each vetted user the message is being sent to. In this case it would be the 14 other CMH employees and the 3 trusted vendors, but not the local politicians.
         (1) The message log contains who the message is sent from, who it is sent to, the date the message was sent, and a hash of the message.
         (2) Our application sends the message logs to our data warehouse for storage.
   c) CMH's employees and vendors open their email application and check their email like they normally do.
      i) They see that they have an email from the CEO. They click on the message.
         (1) Safe2Click application creates a message log on the receiving end and then checks to see that there is a matching log in the data warehouse on the server.
            (a) In this case there is. “Your Favorite Name” is displayed at the top of the email using the colors and size the employee chose. The CMH employees and vendors know the following:
            (i) The email was sent from the CEO of CMH and from his computer.
            1. Only a computer with our application can create a message log and store it on the data warehouse. If the message is spoofed using a spoofed address, then there is not a log in the data warehouse and the message would not show up as vetted.
            (ii) The email was not altered in transit.
            1. The email message was hashed when it was sent, and it was hashed when it was received. Those hashes must be the same or the message is not vetted.
            (iii) The employees and vendors know that they can trust the message and its content was sent by CMH's CEO.
            1. They click on the link and visit the Big Brothers and Big Sisters' website and make plans to attend the picnic.
   d) The local politicians open their email application and check their email like they normally do.
      i) They see that they have a message from CMH's CEO for an annual picnic and fundraiser.
      ii) The local politicians do not have our application, so the email shows up as normal.
         (1) They do not know if the message is legitimate or not.
         (2) They do not click on the link because of the fear of a phishing attack. Some of them would call to see if this were sent by the CEO and was a legitimate email. Some of them would ignore it.

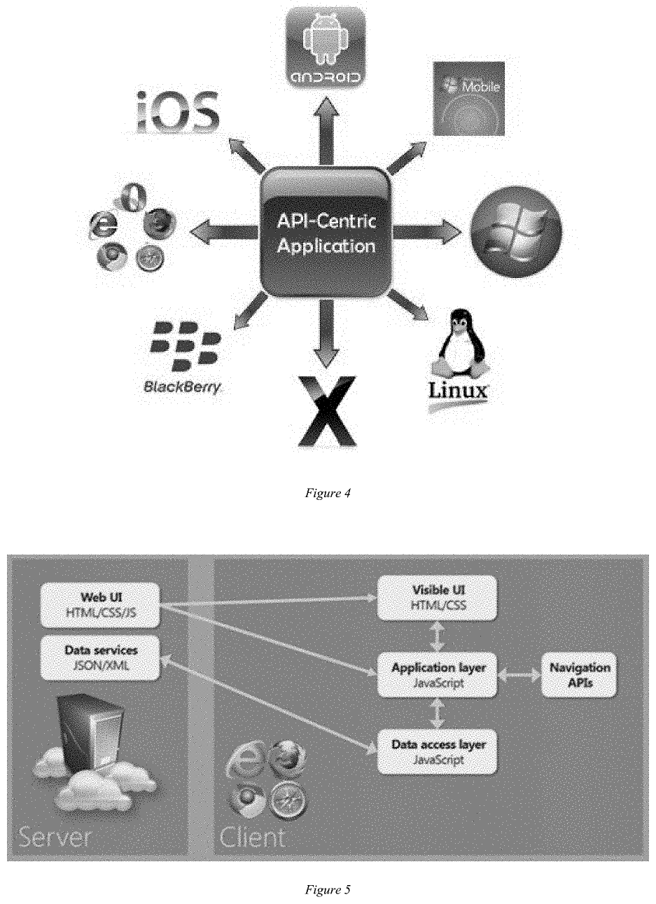

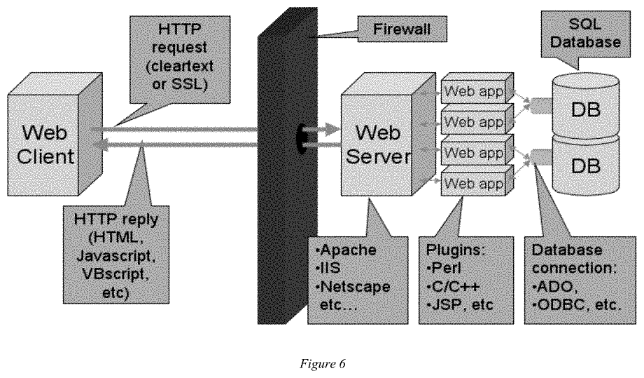

FIG. 4 shows that this application can be installed on any operating system and smart device. The application can use the standard server/client, web, and web/hybrid architectures. FIGS. 5 & 6 elaborates on these different architectures.

1. (canceled)

2. (canceled)

3. A system of claim 12 wherein an email authentication comprises of DMARC, DKIM, and SPF methodologies.

4. (canceled)

5. (canceled)

6. The system of claim 12 wherein an enhancement comprises a confirmed personalized name with a set limit amount of characters.

7. The system of claim 12 wherein an enhancement comprises a user-selected-personalized font.

8. The system of claim 12 wherein an enhancement comprises a user-selected-personalized size of font.

9. The system of claim 12 wherein an enhancement comprises a user-selected-personalized color of font.

10. The system of claim 12 wherein an enhancement comprises a user-selected-personalized color of the banner.

11. The system of claim 12 wherein an enhancement comprises a user-selected-personalized height of the banner.

12. A user-customizable electronic message notification system that verifies the authenticity of a sender and allow a user to personalize a visual notification to inbound messages of said verified sender that comprises:
a banner, a font, colors, logos, shapes, pictures and personalized name;
works in conjunction with but is not limited to current messaging technologies such as email and SMS;
resides on a client end of the user-customizable electronic message notification system and thus does not travel from your device;
does not alter the original message.
